(19) United States
(12) Patent Application Publication
(10) Pub. No.: US 2015/0052008 A1
(43) Pub. Date: Feb. 19, 2015

(54) Mobile Application For Hair Extensions

(71) Applicant: Steven I. Campbell, Jackson, MS (US)

(72) Inventor: Steven I. Campbell, Jackson, MS (US)

(73) Assignee: iWeave International, Atlanta, GA (US)

(21) Appl. No.: 14/460,917

(22) Filed: Aug. 15, 2014

Related U.S. Application Data
(60) Provisional application No. 61/867,002, filed on Aug. 16, 2013.

(51) Int. Cl. G06Q 30/06; G06Q 50/00; A45D 44/00

(52) U.S. Cl. CPC G06Q 30/0633; A45D 44/005; G06Q 30/0643; G06Q 50/01
USPC 705/26.8

(57) ABSTRACT

The subject disclosure pertains to systems and methods for viewing and purchasing hair extensions via a mobile application. A user can upload a photograph to a mobile device or server using the mobile application. The image of a selected hairstyle can be displayed on the mobile device display overlaying the photograph image in a mobile app interface. The user can add hair extensions associated with the selected hairstyle to a virtual shopping cart. The user can go directly from the user interface displaying the photograph and hairstyle to the virtual shopping cart to purchase the hair extensions. Users can also search for and purchase hair care products. The user can also search for stylists who can put in the hair extensions.

### CROSS REFERENCE TO RELATED APPLICATIONS

This application claims benefit under 35 U.S.C. §119(e) of U.S. Provisional Patent Application No. 61/867,002, filed Aug. 16, 2013, the contents of which is incorporated herein by reference in its entirety.

### TECHNICAL FIELD

The present invention is directed generally to the purchasing of goods via a mobile application and more specifically, for purchasing hair related products.

### BACKGROUND

A large percentage of the distribution and retail sale of hair extensions is controlled by one unified group. Because hair extensions are a scarce resource controlled by this unified group, it can be difficult for new comers to enter the market to distribute and sell hair extensions on a mass scale. This has resulted in a number of relatively small, independent, and disjointed distributors of hair extensions. Due to this lack of unification among newcomers, it can be difficult for consumers to shop for hair extensions. Most hair extension distributers and retailers sell their products over the Internet (i.e., e-commerce). Consumers must visit different online sites to shop for hair extensions. Because of the small scale operation of these distributors, there are limited funds to create efficiencies and innovate in the distribution of hair extensions.

### SUMMARY

Implementations of this disclosure provide systems and methods for a user to shop for and purchase hair extensions from a mobile application. In some implementations, the user can shop for and purchase other hair care products. In some implementations, the user can utilize a search functionality to find a desired product.

In some implementations, a user can take a photograph containing the face of a person and alter the photograph to display a pre-stored hairstyle on the head of the person. In some implementations, the user can use a pre-stored photograph. Implementations of this disclosure allow the user to display multiple hairstyles on the head of the person. A user may make one or more selections, including bulk selections, from the multiple hairstyles displayed. Once the user selects a hairstyle, implementations of this disclosure allow the user to purchase the hair extensions associated with the selected hairstyle. In some implementations, the user can select to add the hair extensions associated with the selected hairstyle to a virtual shopping cart. In some implementations, the user can go directly from the user interface displaying the uploaded picture and selected hairstyle to a virtual shopping cart to purchase the hair extensions associated with the hairstyle selected. This implementation is called “picture-to-purchase.” Although there are mobile applications that allow users to visualize themselves with a particular hairstyle, these applications are not m-commerce solutions and users cannot purchase hair extensions from these mobile applications.

In some implementations, the user can store the altered images with the selected hairstyle. In some implementations, the user can send or post (e.g., to YouTube®, Instagram®, Twitter®, Facebook®) the altered image (e.g., via electronic mail message, chat message, comments left on a user's webpage, or short message service (SMS) text messages).

In some implementations, the user also can purchase goods associated with the selected hairstyle. Implementations of this disclosure can locate salons and/or stylists within a geographical area from the user. In some implementations, the salons and/or stylists are preselected salons and/or stylists. In some implementations, when purchasing product, the user can input a code uniquely identifying a stylist.

In some implementations, third party distributors may be able to receive purchase orders to fulfill the order. In this way, in some implementations, relatively small, independent, and disjointed distributors can become unified to offer a more convenient shopping experience to the end user, among other advantages.

To facilitate users shopping for and purchasing hair extensions using a portable electronic device, a mobile application (hereinafter “iWeave App”) is downloaded onto the portable electronic devices of the users. A mobile operation system specific iWeave App can be provided for different mobile operating systems such as, but not limited to, Android from Google Inc., iOS from Apple Inc., a BlackBerry mobile OS from BlackBerry, and Windows Phone from Microsoft.

In some implementations, the iWeave App interfaces with an iWeave web server to perform the function set above. Through the iWeave App, a constant connection can be maintained between the iWeave server and the portable electronic device.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

### BRIEF DESCRIPTION OF DRAWINGS

The following description is better understood when read in conjunction with the appended drawings.

FIG. 1 is a functional block diagram of an exemplary system of an embodiment of the disclosure.

FIG. 2 is a representation of an exemplary user screen in accordance with an embodiment of the disclosure.

FIG. 3 is a representation of an exemplary user screen in accordance with an embodiment of the disclosure.

FIG. 4 is a representation of an exemplary user screen in accordance with an embodiment of the disclosure.

FIG. 5A is a flow chart of a method in accordance with an embodiment of the disclosure.

FIG. 5B is an isolated portion of the flow chart from FIG. 5A with regard to iSylist.

FIG. 5C is an isolated portion of the flow chart from FIG. 5A, with regard to shopping for a hair product.

FIG. 5D is an isolated portion of the flow chart from FIG. 5A with regard to locating stylist.

### DETAILED DESCRIPTION

The subject matter of the various embodiments is described with specificity to meet statutory requirements. However, the description itself is not intended to limit the scope of the disclosed subject matter. Rather, the inventor has contemplated that the claimed subject matter might also be embodied in other ways, to include different steps or elements similar to the ones described in this document, in conjunction with other present or future technologies. It should be understood that the explanations illustrating the mobile application for hair extensions are exemplary. The following description is illustrative and not limiting to any one aspect.

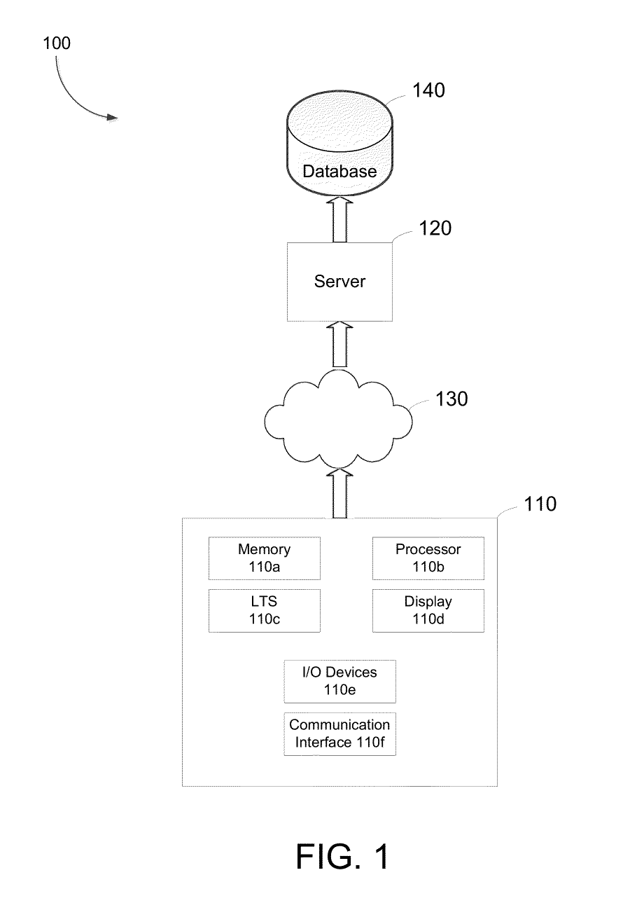

FIG. 1 illustrates iWeave system 100 according to certain implementations of the present disclosure. iWeave system 100 includes a plurality of portable electronic devices such as portable electronic device 110, iWeave server 120, and network 130.

When a portable electronic device (e.g., portable electronic device 110) downloads the iWeave App (e.g., from an app store), the iWeave App interfaces with iWeave server 120 via a network (e.g., network 130). The iWeave App and/or any related, required, or useful applications, plug-ins, readers, viewers, updates, patches, or other code for executing the iWeave App can be downloaded via a network or installed on portable electronic device 110 in any other known manner.

Network 130 can be implemented as, or can be a part of, a storage area network (SAN), personal area network (PAN), local area network (LAN), a metropolitan area network (MAN), a wide area network (WAN), a wireless local area network (WLAN), a virtual private network (VPN), an intranet, the Internet or any other appropriate architecture or system that facilitates the communication of signals, data and/or messages (generally referred to as data) via any one or more wired and/or wireless communication links. The network(s) can include any communication link known to persons of skill, including for example, cloud, cellular or satellite transmission, magnetic or optical media, radio frequency transmission, microwave or fiber optic transmission, or communications via Internet, cable, or satellite providers.

Portable electronic device 110 can be any type of portable or mobile electronics device, such as for example, a smartphone, a cell phone, a mobile telephone, personal digital assistant (PDA), laptop computer, tablet-style computer, or any other device that a user can hold in his or her hand. For example, in some embodiments, the portable electronic device 110 can be a smart phone, such as an iPhone by Apple Inc., a Blackberry phone by RIM, or a phone using an Android operating system (OS), for example.

As illustrated in FIG. 1, portable electronic device 110 can include memory 110a, processor 110b, location tracking system (LTS) 110c, display 110d, input/output devices 110e, and communication interface 110f.

Memory 110a can store the iWeave App and other data, such as location data, configuration settings of the device, and any other data required for the iWeave App to operate, etc. Memory 110a can comprise one or more devices suitable for storing electronic data, e.g., RAM, DRAM, ROM, internal flash memory, external flash memory cards (e.g., Multi Media Card (MMC), Reduced-Size MMC (RS-MMC), Secure Digital (SD), MiniSD, MicroSD, Compact Flash, Ultra Compact Flash, Sony Memory Stick, etc.), SIM memory, a rewritable optical disk, a rewritable magnetic tape, and/or any other type of volatile or non-volatile memory or storage device. As described herein, memory is a tangible, physical, and concrete article of manufacture and thus not a signal per se. The iWeave App can be embodied in any combination of software, firmware, and/or any other type of computer-readable instructions.

Processor 110b can include a microprocessor, a microcontroller, a digital signal processor (DSP), an application specific integrated circuit (ASIC), electrically-programmable read-only memory (EPROM), or a field-programmable gate array (FPGA), or any other suitable processor(s), and can be generally operable to execute instructions for the iWeave App, as well as providing any other functions of portable electronic device 110. Processor 110b can be a number of processors, a multi-processor core, or some other type of processor, depending on the particular implementation. Processor 110b can be implemented using a number of heterogeneous processor systems in which a main processor is present with secondary processors on a single chip.

Portable electronic device 110 can include location tracking system 110c for determining the geographic location of portable electronic device 110. For example, location tracking system 110c can include a global positioning system (GPS) receiver for accessing a GPS application function call that returns the geographic coordinates (i.e., the geographic location) of portable electronic device 110. As another example, the positioning system can utilize any suitable trilateration or triangulation technique to determine the geographic coordinates of portable electronic device 110. In some embodiments, location tracking system 110c can determine various measurements (e.g., signal-to-noise ratio (“SNR”) or signal strength measurements) of a network signal (e.g., a cellular telephone network signal, a wireless network access point or “hot spot,” or any other suitable network signal) associated with portable electronic device 110 to determine its location.

Display 110d can comprise an LCD screen (e.g., thin film transistor (TFT) LCD or super twisted nematic (STN) LCD), an organic light-emitting diode (OLED) display, or any other suitable type of display. In some embodiments, display 110d can be an interactive display, such as a touch screen.

Input/output interface 110e can include any suitable interfaces allowing a user to interact with portable electronic device 110. In some implementations, I/O interface 110e includes hardware, software, or both providing one or more interfaces for communication between portable electronic device 110 and one or more I/O devices. Portable electronic device 110 can include one or more of these I/O devices, where appropriate. One or more of these I/O devices can enable communication between a person and portable electronic device 110. As an example and not by way of limitation, an I/O device can include a keyboard, keypad, microphone, monitor, mouse, printer, scanner, speaker, still camera, stylus, tablet, touch screen, trackball, video camera, another suitable I/O device or a combination of two or more of these.

An I/O device can include one or more sensors. This disclosure contemplates any suitable I/O devices and any suitable I/O interfaces 110e for them. Where appropriate, I/O interface 110e can include one or more device or software drivers enabling processor 110b to drive one or more of these I/O devices. I/O interface 110e can include one or more I/O interfaces 110e, where appropriate. Although this disclosure describes and illustrates a particular I/O interface, this disclosure contemplates any suitable I/O interface.

Communication interface 110f can any interface that enables communication between portable electronic device 110 and external devices, machines and/or elements such as network 130 or an app store. Communication interface 110f can include, but is not limited to, a modem, a Network Interface Card (NIC), an integrated network interface, a radio frequency transmitter/receiver (e.g., Bluetooth, cellular, NFC), a satellite communication transmitter/receiver, an infrared port, a USB connection, or any other such interfaces for connecting portable electronic device 110 to other computing devices and/or communication networks such as the Internet. Such connections can include a wired connection or a wireless connection (e.g., a wireless network connection conforming to IEEE 802.11 specifications) though it should be understood that communication interface 110f can be practically any interface that enables communication to/from portable electronic device 110.

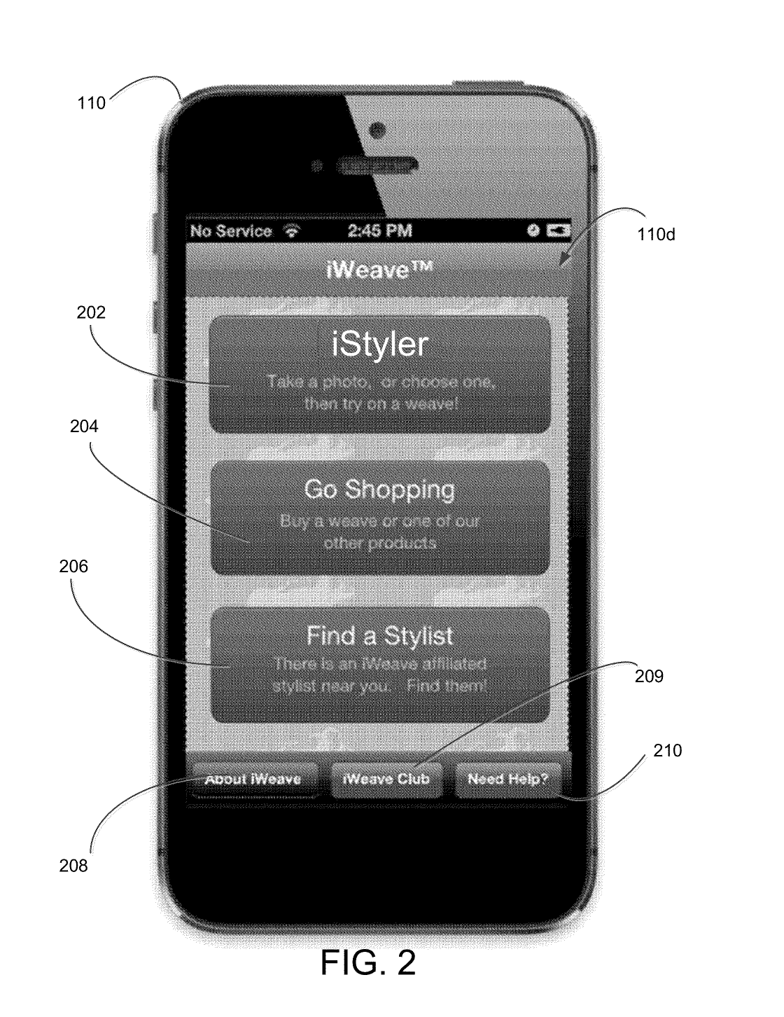

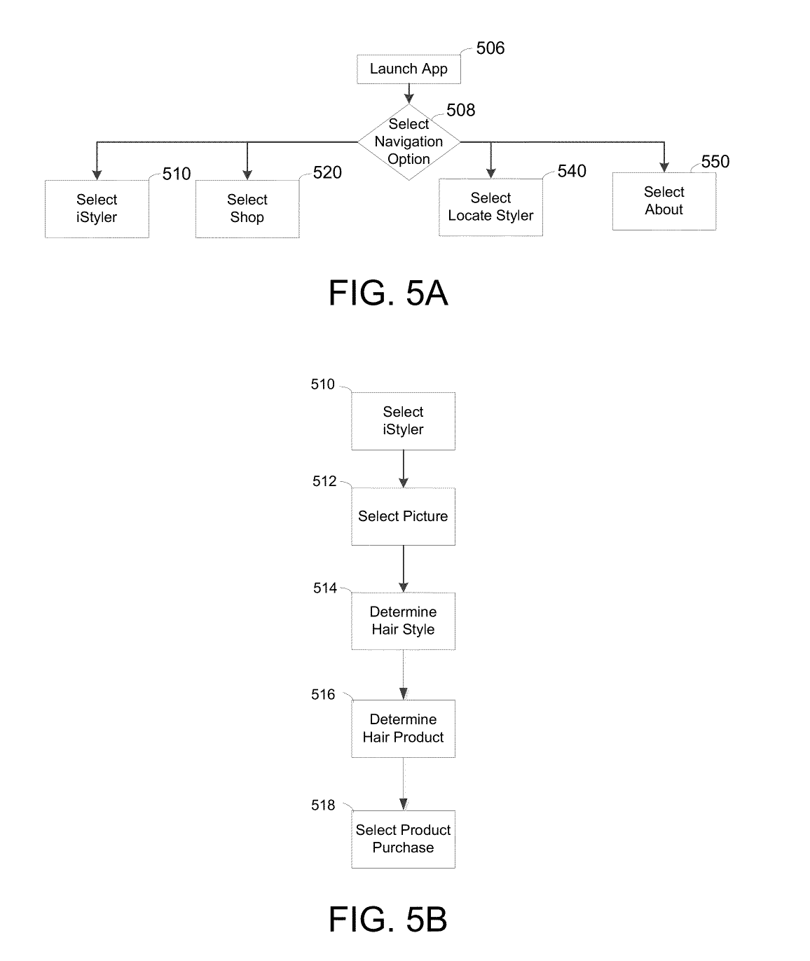

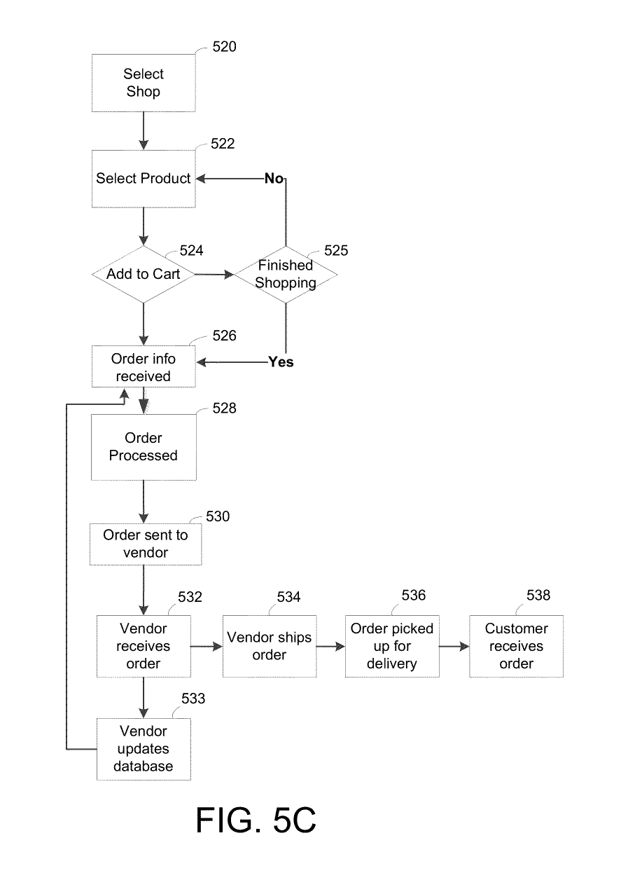

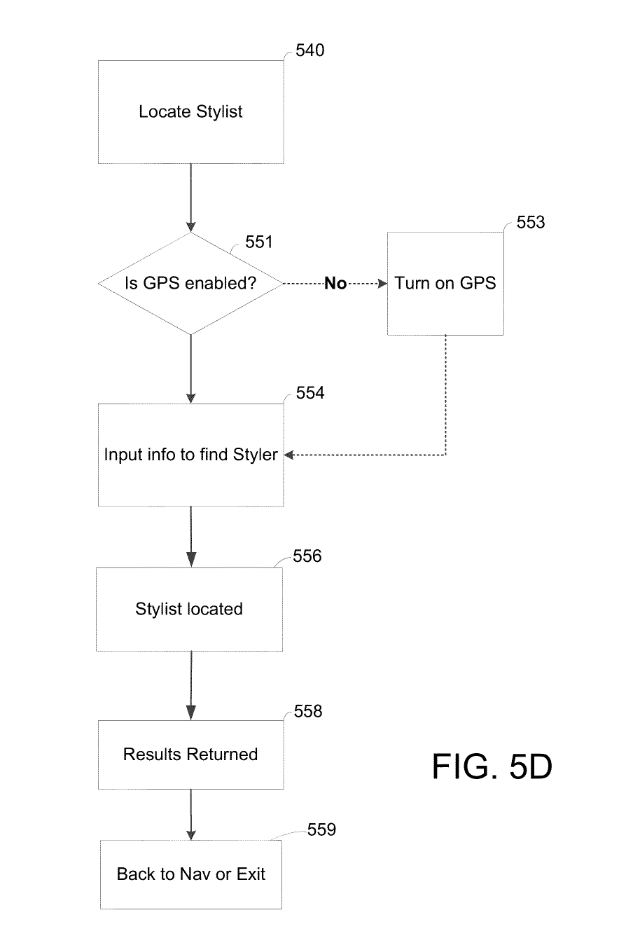

FIG. 2 through FIG. 4 illustrate example screen shots of the iWeave App launched on a portable electronic device. Further details are discussed with regard to FIG. 5A through FIG. 5D. FIG. 2 illustrates a mobile device with a display for executing transactions with regard to hair products, which may include hair extensions. Display 110d of FIG. 2 includes a menu button 202 for iStyler, which allows for a user to virtually “try on” a hair extension. Menu button 204 may give a user access to shop different hair extensions. Menu button 206 may give a user access to a search application that allows for a person to find a stylist to insert or style the hair extensions. There also may be other menu buttons such as, menu button 208 for further information about aspects of the company sponsoring the hair extension application, a menu button 209 for a social network forum for hair extension related topics, and a menu button 210 for directing a user to help.

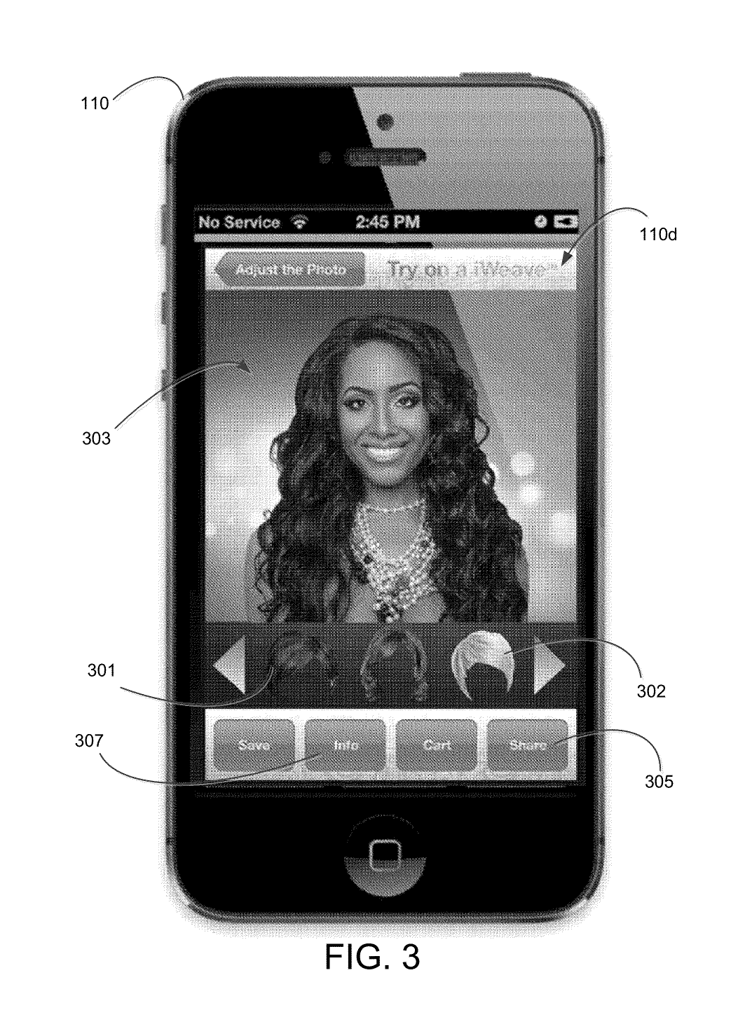

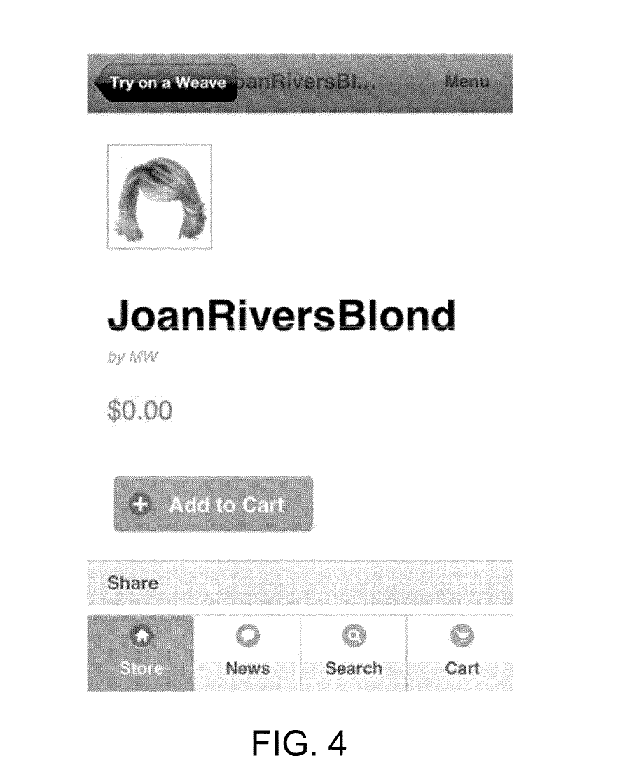

FIG. 3 illustrates an exemplary user interface after a menu button is selected, such as menu button 202 for iStyler. As shown in FIG. 3, display 110d of mobile device 110 shows a picture 303 of a person, a selection of hairstyles (e.g., hairstyle 301 and hairstyle 302), as well as menu buttons (e.g., menu button 305 for sharing a portion of what is shown on display 110d). As discussed, implementations of the disclosure allow a user to take or use a photograph containing the face of a person and alter the photograph to display a pre-stored hairstyle or hair product on the head of the person, such as hairstyle 301 and hairstyle 302. In some implementations, the user can upload a pre-stored photograph. Implementations of this disclosure allow the user to display multiple hairstyles or hair products on the head of a person. As shown in FIG. 3, once the user selects a hairstyle, implementations of this disclosure allow the user to purchase a hair product (e.g., hair extensions) associated with the selected hairstyle. The user can also select menu button 307 for more information about the hairstyle or the hair product. If a user chooses to shop for and purchase products by selecting menu button 204, for example, FIG. 4 illustrates a sample screen shot of a product selected for the shopping functionality.

FIG. 5A illustrates an exemplary method for electronic transactions associated with hair products using a mobile device (e.g., mobile device 110). The transactions may include viewing, virtually trying on, or purchasing hair extensions. At block 506, an application for electronic transactions associated with hair extensions (i.e., iWeave app) is launched. At block 508, the iWeave app may load a navigation menu with navigation options on display 110d. Based on the navigation options of block 508, a user may select iStyler at block 510, select Shop at block 520, select Locate Styler at block 540, or select About at block 550. The navigation options of block 508 can be similar to those shown in FIG. 2, among other possible navigation options.

FIG. 5B illustrates a portion of the method of FIG. 5A with regard to iStyler or Shop. Generally, the iStyler selected at block 510 can be any interface or application (e.g., menu button 202) that allows users to view images of hairstyles overlaying a photograph of a person. At block 512, a picture may be selected from pictures previously in memory 110a of mobile device 110 or selected from a server (e.g., server 120). A camera of mobile device 110 or another camera may have taken the selected picture. The selected picture may be a picture of the user (e.g., consumer) that was taken before launching the iWeave App or after launching the iWeave App (e.g., iWeave App may provide access to camera in order for user to take a picture). In addition, the selected picture may be a photo of someone other than the user, but when user is planning to purchase, it is preferable that the picture is a person with similar features to the person who will ultimately use the one or more hair products. The selected picture may be edited to remove unwanted background (e.g., another person). The selected picture may be used to display a determined hair product (block 514) and determined hairstyle (block 516).

At block 514, a hairstyle is determined and may be applied to the face of the selected picture of block 512. A list of hairstyles (or hairstyle automatically applied to the face in the picture) may be prepopulated based on factors such as, a user profile, common purchases by the current or other users (e.g., common purchases by the user or other users in a particular location), or facial features detected in the selected picture. With regard to facial features, the facial features that are analyzed may be based the position of the nose, eyes, or mouth, the shape of the nose, eyes, or mouth, or the shape of the face, among other things. The factors may help determine the color, length, or curl of the list of hairstyles that are shown on display 110d. A user may also manually select the list of hairstyles shown on display 110d. As discussed, there may be a plurality of hairstyles, such as hairstyle 301 or hairstyle 302 that overlays the face of the person in the picture 303. Facial recognition technology can be used to automatically recognize where to display the style in the picture. For example, based on the recognition of facial features, such as eyes, nose, lips, cheeks, and ears, the hairstyle may automatically be placed around the face and appropriately cover (or not cover) the ears, cheeks, and other facial features. A user may also manually adjust a selected hairstyle.

With continued reference to FIG. 5B, at block 516, a hair product may be determined that assists in enabling the hairstyle. This block 516 (as well as many other blocks) may be completed to be executed in a different order based on the situation. For example, the hair product may be selected and then the different hairstyles may then be shown. A list of hair products that enable the style may be shown on display 110d that may include wigs or hair extensions. Additional products that enable the selected hairstyle of block 514 may be listed at this block 516, as well as the shopping block. The additional products may include glue, bobby pins, wig caps, or curling irons, among other things. The list of hair products shown may be based on factors of the hair of the displayed hairstyle, such as the sheen, the length, the color, the type of curl, or the need to apply heat to the hair for the displayed hairstyle.

With continued reference to block 516 of FIG. 5B, the list of hair products may also be prepopulated based on factors such as, a user profile, a selected time frame for the hair style or use of the hair product, common purchases by the current or other users (e.g., common purchases by the user or other users in a particular location), or facial features detected in the selected picture. In an example, a user may determine that it is desired that a hairstyle last a minimum amount of time. So factors such as the climate the hairstyle will be worn in and the frequency a consumer of the hair may workout (or tendency to sweat) can be used in determining the prepopulated (e.g., recommended) hair products, as well as the hair style. A user may be alerted via display 110d with regard to whether a certain hair product is not compatible with a particular hairstyle or whether using a certain hair product for a particular hairstyle may reduce the life of the hair product (e.g., excessive need to flat iron a type of hair extension). The color, sheen, or the like of a selected hairstyle of block 514 may be updated on display 110d based on the selected hair product at block 516.

At block 518, the user may select a product to purchase. This may be based on viewing the hairstyles and hair products on a pictures, as discussed with regard to step 512, 514, and 516. The user may follow the shopping process as discussed with regard to FIG. 5C. Instead of shopping, as shown in block 518, the user may save the edited picture or share the edited picture. In 518, options can be provided to save the image, share the image, and/or shop. The image can be saved, for example, in memory 110a, server 120, or database 140 from FIG. 1. The image can be shared via a social media site such as Facebook®, Instagram®, or Twitter®, as well as email, text messaging, or other sharing means. After saving or sharing the image, the user can have the option to return to the navigation screen or exit the application. The process of block 510 through block 516 can be referred to as an iStyle process.

It is contemplated herein that hair extensions may be considered in some way different from wigs. Wigs are usually placed over the head like a cap. Alternatively, hair extensions are usually sewn, woven, glued, or otherwise attached to a person's existing hair or scalp. In many instances with regard to hair extensions, it is preferred to not only match hair to facial features, but also length and texture of natural hair of a consumer. Therefore when automatically showing one or more hair products or hairstyles, with regard to hair extensions, other factors may include the texture of permed hair of the consumer, texture of natural hair of the consumer when heat is applied (e.g., flat ironed), and texture of natural hair of the consumer when no heat is applied.

FIG. 5C illustrates a portion of the method of FIG. 5A with regard to shopping. The user can have the option to shop as shown in block 520. Shopping at block 520 may occur using any interface on a mobile device (or other computing device) in which products can be purchased. Shopping functionality may be accessed from different parts of the mobile application. For example, shopping functionality interface 520 can be accessed from a navigation menu or directly from the image of the hairstyle overlaying the picture. At block 522, one or more hair products can be selected. Hair products can be merchandise on sale for purchase. A hair product can be, for example, the hair extension associated with the hairstyle selected in iStyle process 514 and 516. A hair product can also be hair care merchandise, such as shampoo, conditioner, among other things. At block 524, selected products can be added to a virtual shopping cart. At block 525, a check can be made to determine if shopping has been completed. The check can be a prompt in the mobile app asking if shopping is completed. Shopping can also be deemed completed if the user proceeds to block 526. At block 526, order information can be received. Order information can be the payment and shipping information of the purchaser. At block 528, the order can be processed. Processed can mean that the order information has been received and accepted. Checks can be done to ensure that the payment information and shipping address are valid. In one embodiment of the invention, block 526 and block 528 can be performed using third party software, such as eCommHub® or Shopify®. The purchased products can then be shipped to the purchaser at the shipping address provided.

In one aspect, shown in 530, the order can be sent to a vendor to be completed. A vendor can be any third party that can fulfill purchase orders. In 532, a vendor can receive the order. In 533, the vendor can update a database with the order information. In 534, the vendor can ship the order to the user. In 536, a delivery service can pick up the order for delivery. The order can be delivered, for example, by the vendor or a separate delivery service. In 538, the customer can receive the order.

FIG. 5D illustrates a continued portion of the method of FIG. 5A where Locate Styler is selected from a navigation menu. A stylist can be anyone capable or in the business of putting in hair extensions or otherwise styling hair. A stylist can be referred to as an iStyler. At block 551, it can be determined whether GPS of the mobile device is enabled. If the GPS is not enabled then at block 553, the GPS of the mobile device can be activated. The mobile device can also indicate to the user that the user should activate the GPS. At block 554, information can be input to find a stylist. The input can be any information that can be used to locate a stylist. For example, the input can be the location of the user, the location or geographic area where the user would like to go to a stylist, a specific code assigned to a particular stylist, or criteria for the type of stylist the user would like to find. Other examples of input can be the type of hairstyle (block 514), the hair product (516), any of the factors discussed above with regard to determining a hairstyle or hair product. The criteria can include price, experience, ratings, or other factors. At block 556, a stylist can be found based on the input. At block 558, the results can be returned to the user and shown on display 110d. The results may be a list of one or more stylists that conform to the input of block 554. At block 559, the user may have the option to return to the navigation screen and the option to exit the application.

As an example, a user orders hair extensions via the iWeave mobile app. The user then launches the iWeave mobile app to find a stylist who can put the hair extensions in. The user turns on the GPS on her mobile device and launches the iStyler on her mobile app. The user chooses to find the stylist closest to her, and so selects that option in the app. The application then locates the nearest stylists and returns a set of results for the user to choose from.

In summary, a user may download and launch an application for viewing and purchasing hair products, such as hair extensions, on a mobile device. As an example, a user launches the iWeave mobile app on a mobile device. The app provides the user with a set of navigation options. The user chooses the iStyler option. The mobile app opens the iStyler. The user uploads a photograph of his or her head using the mobile app. The mobile app displays the photograph of the user on the mobile device. The user selects a hair extension and the mobile app displays the selected hair extension overlaying the user's photograph such that the hair extension appears where the user's hair in the photograph would normally appear. The user saves the image and shares the image with his or her friends on a social networking site. The user selects an option to purchase the selected hair extension. The mobile app places the hair extension in a virtual shopping cart. The user decides to shop further, and finds a few other items to place in the virtual shopping cart. The user navigates to the order screen of the mobile app. The mobile app receives shipping and billing information from the user. The order is completed and the order information is sent to a vendor. The vendor processes the order and ships the purchased products to the user, which the user later receives.

In some implementations, one or more aspects of at least one embodiment can be implemented by representative instructions stored on a machine-readable medium which represents various logic within the processor, which when read by a machine causes the machine to fabricate logic to perform the techniques described herein. Such representations, known as “IP cores,” can be stored on a tangible, machine-readable medium and supplied to various customers or manufacturing facilities to load into the fabrication machines that actually make the logic or processor.

In some implementations, the processes and logic flows describe in this specification can be performed by one or more programmable processors executing one or more computer programs to perform functions by operating on input data and generating output thereby tying the process to a particular machine (e.g., a machine programmed to perform the processes described herein). The processes and logic flows can also be performed by, and the apparatus can also be implemented as, special purpose logic circuitry, e.g., an FPGA or an ASIC.

Some embodiments can be implemented, for example, using a machine or tangible computer-readable medium or article which can store an instruction or a set of instructions that, if executed by a machine, can cause the machine to perform a method and/or operations in accordance with the embodiments.

Such a machine can include, for example, any suitable processing platform, computing platform, computing device, processing device, computing system, processing system, computer, processor, or the like, and can be implemented using any suitable combination of hardware and/or software. The machine-readable medium or article can include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. To the extent not included above, computer readable media suitable for storing computer program instructions and data also includes all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD ROM disks. The processor and the memory can be supplemented by, or incorporated in, special purpose logic circuitry.

The instructions can include any suitable type of code, such as source code, compiled code, interpreted code, executable code, static code, dynamic code, encrypted code, and the like, implemented using any suitable high-level, low-level, object-oriented, visual, compiled and/or interpreted programming language. To the extent not included above, such instructions also can comprise, for example, interpreted instructions, such as script instructions, e.g., JavaScript or ECMAScript instructions, or executable code, Standard interchange language (SIL), Component Object Model (COM) enabled programming languages, or other instructions stored in a computer readable medium including existing and future developed instructions specific to portable electronic devices, mobile applications, and servers.

Unless specifically stated otherwise, it can be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

To provide for interaction with a user, implementations of the subject matter described in this specification can be operable to interface with a computing device that is integrated with or connected to (directly or indirectly) a display, such as a cathode ray tube (CRT) or liquid crystal display (LCD) monitor, for displaying information to the user. To provide for input by a user to the computer, implementations of the subject matter described in this specification further can be operable to interface with a keyboard, a pointing device (e.g., a mouse or a trackball), scanner, a barcode reader, magnetic strip reader, or any other input device.

The described features, structures, or characteristics can be combined in any suitable manner in one or more embodiments. In the above description, numerous specific details are provided for a thorough understanding of embodiments of the invention. One skilled in the relevant art will recognize, however, that embodiments of the invention can be practiced without one or more of the specific details, or with other methods, components, materials, etc. In other instances, well-known structures, materials, or operations may not be shown or described in detail. Furthermore, while this specification contains many specific implementation details, these should not be construed as limitations on the scope of any invention or of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the implementations described above should not be understood as requiring such separation in all implementations, and it should be understood that the described program components and systems can generally be integrated together in a single software product or packaged into multiple software products.

Those skilled in the art will appreciate from the foregoing description that the broad techniques of the embodiments of the present invention can be implemented in a variety of forms. Therefore, while the embodiments of this invention have been described in connection with particular examples thereof, the true scope of the embodiments of the invention should not be so limited since other modifications and other embodiments will become apparent to the skilled practitioner upon a study of this disclosure.

Reference throughout this specification to “an embodiment” or “implementation” or words of similar import means that a particular described feature, structure, or characteristic is included in at least one embodiment of the present invention. Thus, the phrase “in an embodiment” or a phrase of similar import in various places throughout this specification does not necessarily refer to the same embodiment.

What is claimed:

1. A method comprising:
receiving, by a processor, a first image comprising the face of a person;
displaying, by the processor, the first image on the display of a mobile device;
receiving, by the processor, a hairstyle selection;
displaying, by the processor, a second image on the mobile device comprising the hairstyle selection overlaying the first image;
receiving, by the processor, a request to purchase hair extensions associated with the selected hairstyle;
generating, by the processor, a purchase order for the hair extension.

2. The method of claim 1, further comprising receiving, by the processor, a request to purchase other hair care products.

3. The method of claim 1, further comprising saving, by the processor, the image to a memory.

4. The method of claim 1, further comprising sending or posting, by the processor, the second image.

5. The method of claim 1, further comprising locating, by the processor, at least one stylist.

6. The method of claim 5, further comprising using, by the processor, the mobile device's GPS to locate at least one stylist.

7. The method of claim 1, further comprising sending, by the processor, the purchase order to a third party vendor.

8. A computer-readable storage medium storing executable instructions that when executed by a processor cause the processor to implement steps comprising:
receiving first display information of a first image from a mobile application;
determining the location of a face in the first image;
sending the first display information to the display component of mobile device;
receiving second display information of a second image from the mobile application;
combining the first image and second image such that the second image overlays the first image;
sending third display information of the first image and second image overlaying each other to the display component of a mobile device;
receiving purchase order information from the mobile application; and
providing the purchase order information to a server.

9. The computer-readable storage medium of claim 8, further comprising instructions for storing the second display information in a memory.

10. The computer-readable storage medium of claim 8, further comprising instructions for sending the second display information to a server.

11. The computer-readable storage medium of claim 10, wherein the server is for a social media site, messaging, or email.

12. The computer-readable storage medium of claim 8, further comprising instructions for determining the geographical location of a stylist.

13. The computer-readable storage medium of claim 12, further comprising receiving information from the mobile device's GPS to determine the geographical location of the stylist.

14. The computer-readable storage medium of claim 8, further comprising instructions for sending the purchase order information to the server of a vendor.

15. A system comprising:
a display;
a processor communicatively connected with the display; and
a memory communicatively connected with the processor, the memory having stored thereon executable instructions that when executed by the processor cause the processor to effectuate operations comprising:
receiving first display information of a first image from an application;
determining the location of a face in the first image;
sending the first display information to the display;
receiving second display information of a second image from the application;
combining the first image and second image such that the second image overlays the first image;
sending third display information of the first image and second image overlaying each other to the display; and
receiving purchase order information from the application, the purchase order information based on the third display information.

16. The system of claim 15, further operations comprising for storing the second display information in a memory.

17. The system of claim 15, further operations comprising for sending the second display information to a server.

18. The system of claim 17, wherein the server is for a social media site, messaging, or email.

19. The system of claim 15, further operations comprising determining the geographical location of a stylist.

20. The system of claim 15, further operations comprising receiving information from the GPS of a mobile device to determine the geographical location of the stylist.
